(19) United States
(12) Patent Application Publication
(10) Pub. No.: US 2024/0186665 A1
(43) Pub. Date: Jun. 6, 2024

(54) RECHARGEABLE BATTERY PACK

(71) Applicant: MILWAUKEE ELECTRIC TOOL CORPORATION, Brookfield, WI (US)

(72) Inventors: Eli M. Zidel, Milwaukee, WI (US); Zachery Meyer, Hartland, WI (US); Wyatt R. Silha, Milwaukee, WI (US); Jonathan Quenzer, German Valley, IL (US)

(21) Appl. No.: 18/526,440

(22) Filed: Dec. 1, 2023

Related U.S. Application Data
(60) Provisional application No. 63/430,605, filed on Dec. 6, 2022.

(51) Int. Cl. H01M 50/574; H01M 10/42; H01M 10/48; H01M 50/209; H01M 50/242; H01M 50/519

(52) U.S. Cl. CPC H01M 50/574; H01M 10/4264; H01M 10/482; H01M 50/209; H01M 50/242; H01M 50/519; H01M 2010/4271

(57) ABSTRACT

A battery pack includes a housing defining an interior volume, a cell pack assembly positioned within the interior, a printed circuit board electrically connected to battery cells, electrical contacts in communication with the battery cells via the printed circuit board and providing electrical power to an external device and a detector in electrical communication with the printed circuit board. The cell pack assembly includes battery cells that collectively define a volume, wherein each battery cell includes a body, an anode extending from the body, and a cathode extending from the body. The body of each cell is configured to expand and contract. When the detector determines that the volume of the battery cells meets or exceeds a threshold volume, the detector is configured to generate a signal configured to warn the operator of a status of the stack or stop current from flowing to and from the battery cells.

### CROSS-REFERENCE TO RELATED APPLICATIONS

The present application claims priority to U.S. provisional application No. 63/430,605, filed Dec. 6, 2022, the entire contents of which are incorporated by reference herein.

### FIELD

The present disclosure relates to rechargeable battery packs.

### BACKGROUND

Rechargeable battery packs typically store electrical power in a plurality of individual cylindrically shaped battery cells contained within the housing thereof.

### SUMMARY

In one aspect, the disclosure provides a battery pack including a housing at least partially defining an interior volume therein, a cell pack assembly at least partially positioned within the interior, a printed circuit board electrically connected to the plurality of battery cells, electrical contacts in communication with the plurality of battery cells via the printed circuit board and configured to provide electrical power to an external device and a detector in electrical communication with the printed circuit board. The cell pack assembly includes a plurality of battery cells that collectively define a volume, wherein each battery cell includes a body, an anode extending from the body, and a cathode extending from the body. The body of each of the cells is configured to expand and contract. When the detector determines that the volume of the plurality of battery cells meets or exceeds a threshold volume, the detector is configured to generate a signal configured to warn the operator of a status of the stack or stop current from flowing to and from the plurality of battery cells.

In another aspect, the disclosure provides a battery pack including a housing at least partially defining an interior volume therein, a cell pack assembly at least partially positioned within the interior volume, a printed circuit board electrically connected to the plurality of battery cells, electrical contacts in communication with the plurality of battery cells via the printed circuit board and configured to provide electrical power to an external device, a support positioned between the stack and the printed circuit board, the support being movable with the stack as the volume of the stack changes, a biasing mechanism positioned between the support and the printed circuit board, and a switch positioned between the printed circuit board and the support and in selective communication with the printed circuit board. The cell pack assembly includes a plurality of battery cells configured in a stack having a stack axis, wherein each battery cell includes a body, an anode extending from the body, and a cathode extending from the body. The body of each of the cells is configured to expand and contract. The biasing mechanism is configured to bias the support away from the printed circuit board. When as the volume of the stack expands, the support moves towards the printed circuit board against the bias of the biasing mechanism. When the volume of the stack expands to a threshold volume, the switch is configured to be actuated to generate a signal configured to warn the operator of a status of the stack or to stop current from flowing to and from the plurality of battery cells.

In another embodiment, the disclosure provides a method of measuring expansion a plurality of battery cells in a battery pack. The plurality of battery cells collectively defines a volume, wherein each battery cell includes a body, an anode extending from the body, and a cathode extending from the body. The body of each of the cells is configured to expand and contract. The battery pack including electrical contacts in communication with the plurality of battery cells. The method includes providing a printed circuit board in electrical communication with the plurality of battery cells, and providing a detector in electrical communication with the printed circuit board. When expansion of the plurality of battery cells exceeds a threshold volume, the detector is configured to generate a signal that is configured to warn the operator of a status of the stack or to stop current from flowing to and from the plurality of battery cells.

### BRIEF DESCRIPTION OF THE DRAWINGS

FIG. 1 is a perspective view of rechargeable battery pack.

FIG. 2 is a section view taken along line 2-2 of FIG. 1.

FIG. 3A is a perspective view the rechargeable battery pack of FIG. 1 with the housing removed.

FIG. 3B is a perspective view of an interior housing of the rechargeable battery pack of FIG. 1.

FIG. 3C is a perspective view of a battery cell of the rechargeable battery pack of FIG. 1.

FIG. 4A is a top view of a printed circuit board of the rechargeable battery pack of FIG. 1 according to one embodiment.

FIG. 4B is a top view of a printed circuit board of the rechargeable battery pack of FIG. 1 according to another embodiment.

FIG. 4C is a top view of a printed circuit board of the rechargeable battery pack of FIG. 1 according to another embodiment.

FIG. 5A is a schematic view of a printed circuit board for use with the rechargeable battery pack of FIG. 1.

FIG. 5B another schematic view of the printed circuit board of FIG. 5A.

FIG. 6A is a schematic view of a printed circuit board, support, and biasing mechanism for use with the rechargeable battery pack of FIG. 1.

FIG. 6B is a perspective view of the biasing mechanism of FIG. 6A.

FIG. 6C is another perspective view of the biasing mechanism of FIG. 6A.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

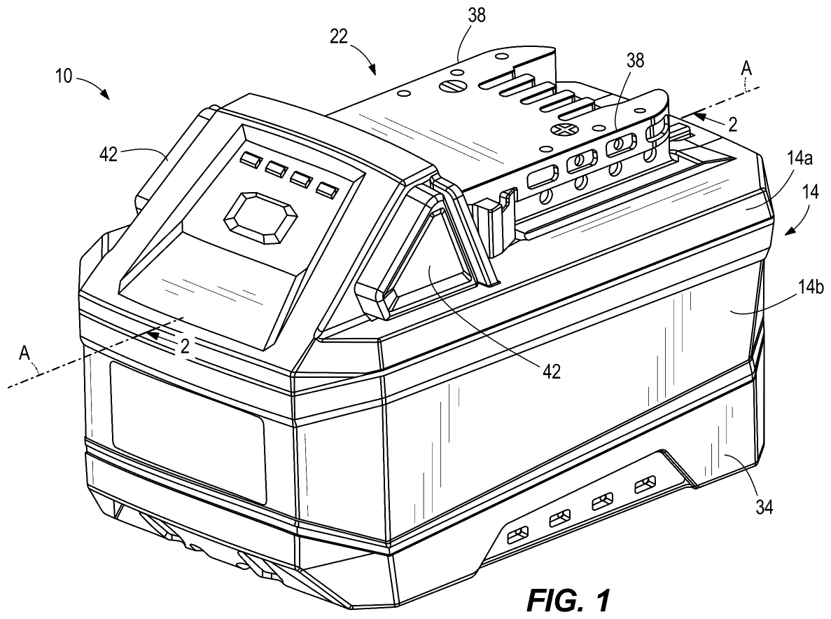

FIGS. 1-3A generally illustrate a rechargeable battery pack 10 for use to selectively power an electrically powered device such as a power tool and the like (not shown). The battery pack 10 includes a housing 14 at least partially defining an interior volume 18 therein, a docking interface 22 at least partially formed by the housing 14, a cell pack assembly 26 positioned within the interior volume 18, and a battery management system 30 in electrical communication with both the cell pack assembly 26 and the docking interface 22 and configured to selectively direct the flow of electrical energy therebetween.

As shown in FIG. 1, the housing 14 of the battery pack 10 is a clamshell construction including a first or upper housing portion 14a and a second or lower housing portion 14b. When assembled, the upper housing portion 14a is fixedly coupled to the lower housing portion 14b (e.g., by snaps, fasteners, and the like) to at least partially enclose the interior volume 18 therebetween. As shown in FIG. 1, housing 14 may also include a pair of rubberized bumpers 34 coupled thereto and configured to help mitigate the transfer of any external shock forces into the housing 14 during operation.

As shown in FIG. 1, the docking interface 22 of the battery pack 10 serves as a mounting location by which the battery pack 10 may be both physically and electrically connected to another device (e.g., the power tool, a battery charger, and the like). In the illustrated embodiment, the docking interface 22 is formed integrally with the upper housing portion 14a and includes a pair of rails 38, a pair of user actuatable latches 42, and one or more electrical contacts 46 each configured to form temporary electrical connection with an external device for the transfer of electrical power therebetween. While the illustrated docking interface 22 is illustrated as a form of “slide and lock” system, it is understood that in other embodiments different forms and styles of connection may be used. In the illustrated embodiment, the housing 14 defines a longitudinal axis A (FIG. 1).

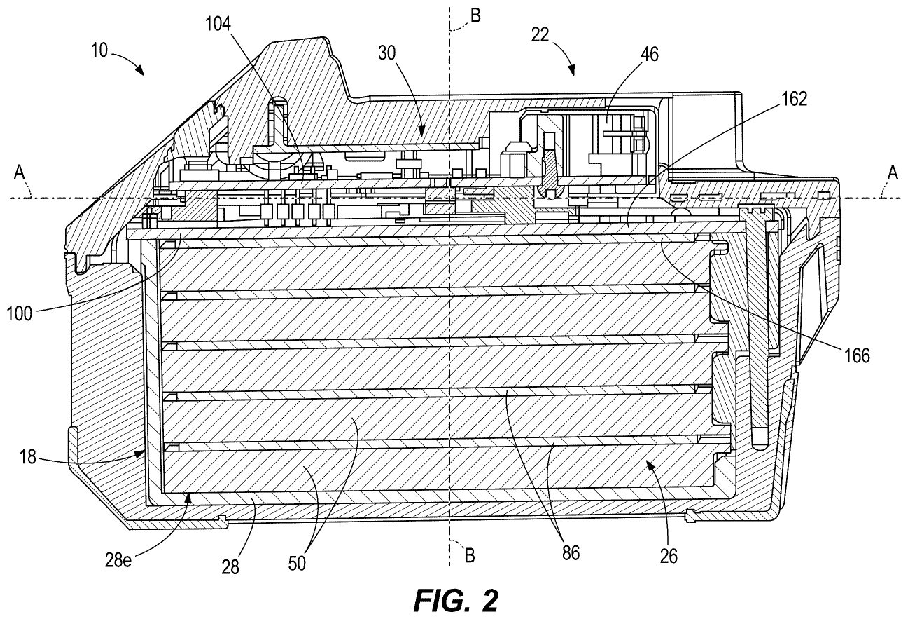

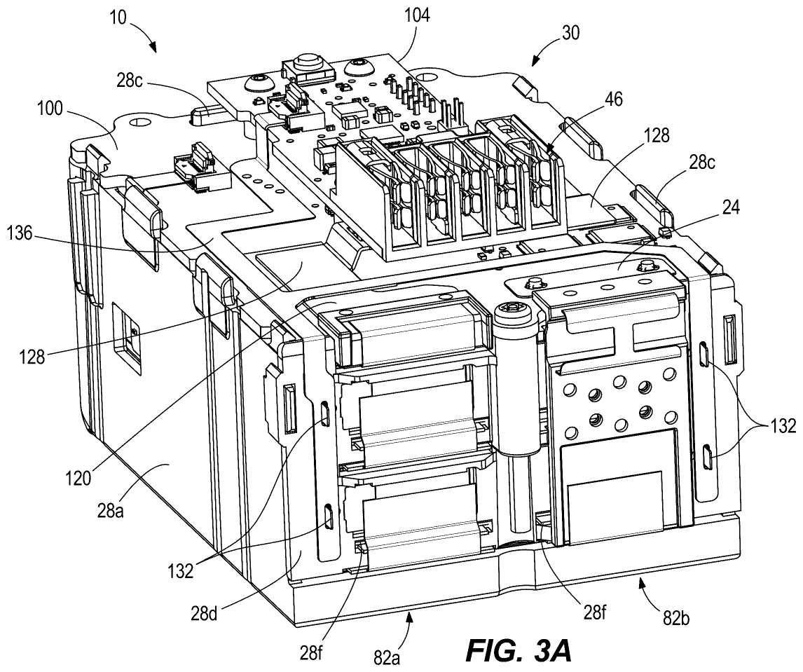

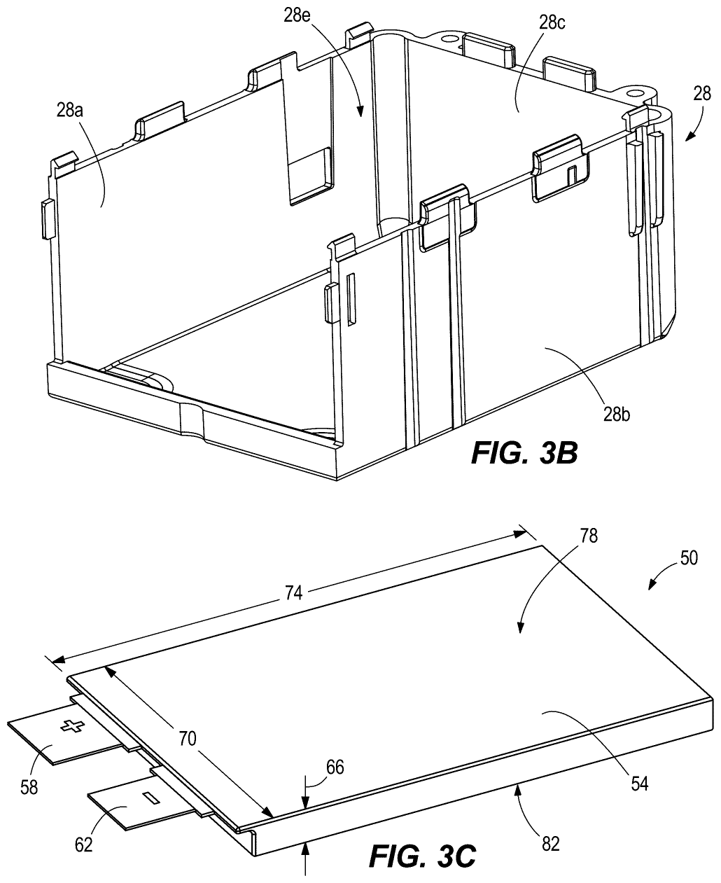

Looking to FIG. 2, the cell pack assembly 26 of the rechargeable battery pack 10 includes a plurality of individual rechargeable battery cells 50 physically arranged and packaged in close proximity to one another in a manner configured to minimize unused space and maximize overall energy storage density. More specifically, the individual cells 50 are coupled or otherwise secured to each other to form a signal stack that, in turn, may be fitted into the interior volume 18 of the housing 14. In the illustrated embodiment, the cell pack assembly 26 includes an interior housing or core box 28 that receives the battery cells 50 and that is positioned within the interior volume 18. With reference to FIGS. 3A and 3B, in the illustrated embodiment, the interior housing 28 includes three walls 28a, 28b, 28c, 28d that partially define at least one opening 28c. In the illustrated embodiment, three of the walls 28a, 28b, 28c are integrally formed, while a fourth wall 28d is coupled to (via a snap fit engagement o or other suitable coupling mechanism) two of the walls 28a, 28c. The fourth wall 28d includes a plurality of slots 28f that are arranged in columns extending perpendicular to the longitudinal axis A of the battery pack 10.

In the illustrated embodiment, each of the individual rechargeable battery cells 50 are also wired together (e.g., in a combination of series and/or parallel groupings) so that the resulting cell pack assembly 26 is configured to provide a single, combined electrical output to the docking interface 22 via the battery management system 30 at the desired power levels. While the illustrated embodiment of the battery pack 10 includes a single cell pack assembly 26 positioned completely within the interior volume 18 thereof, it is understood that in other embodiments of the battery pack 10 additional cell pack assemblies 26 may be present.

As shown in FIG. 3C, each individual battery cell 50 of the cell pack assembly 26 is a pouch-style cell having a pouch or body portion 54, a cathode 58 (e.g., positive terminal or tab) extending outwardly from the body portion 54, and an anode 62 (e.g., negative terminal or tab) extending outwardly from the body portion 54. In the illustrated embodiment, both the positive tab 58 and the negative tab 62 exit the body portion 54 along a single edge thereof (see FIG. 3), however in other embodiments, the positive tab 58 and the negative tab 62 may exit from the body portion 54 at any location as needed to minimize the distances included in the resulting electrical connections.

The body portion 54 of each rechargeable cell 50 includes an external semi-flexible pouch enclosing a sealed internal battery volume (not shown) therein. The sealed battery volume, in turn, contains a number of layered anode and cathode materials interlaced with separators therebetween to produce a rechargeable lithium-polymer cell. The specific layout of the cell being determinate on the desired capabilities of the finished battery pack 10.

While the illustrated rechargeable cells 50 are generally based on lithium-ion technology, it is understood that in other embodiments different forms of rechargeable battery chemistry or layout may be used. In the illustrated embodiment, the construction of the internal battery volume is such that the body portion 54 of the cell 50 is capable of storing 600 Wh/L when fully charged.

In the illustrated embodiment, the body portion 54 of each cell 50 forms a substantially rectangular-prism shape defining a cell height 66, a cell width 70, and a cell length 74. As shown in FIG. 3, the overall shape of the body portion 54 is generally flat and plate-like such that the cell length 74 and cell width 70 are proportionally much larger than the cell height 66. The illustrated shape also produces planar first and second surfaces 78, 82 suitable for stacking. While the illustrated body portions 54 are generally rectangular in cross-sectional shape taken along a cutting plane set parallel to the first and second surfaces 78, 82, it is understood that in other embodiments different cross-sectional sizes and shapes may be used while still maintaining the overall “flat” profile. For example, the exterior profile of the body portion 54 of each cell 50 may be modified to correspond with the size and shape of the available interior volume. The body portion 54 of each cell 50 is configured to expand (e.g., swell) and contract as a result of temperature fluctuations (e.g., increases and decreases, respectively) during use.

As shown in FIG. 3, each individual battery cell 50 of the cell pack assembly 26 is generally organized into a “stacked” configuration within the interior housing 28 such that the top surface 78 of one cell 50 is positioned adjacent to the bottom surface 82 of an adjacent cell 50 and so on. The cells 50 are also oriented such that the perimeter of each body portion 54 is generally aligned producing an overall rectangular-prism shape. In the illustrated embodiment, there are five stacked battery cells 50a-50e, although in other embodiment, there may be greater or fewer battery cells.

With continued reference to FIGS. 2 and 3, the stack of pouch cells 50a-50c within the interior housing 26 creates a first column of cell tabs 82a and a second column 82b of cells tabs. For pouch cells 50a, 50c, 50c oriented with the first side 78 of the pouch cell 50a, 50c, 50e facing the upper housing portion 14a, the positive cell tab 58 is positioned in the first column 82a and the negative cell tab 62 is positioned in the second column 82b. For pouch cells 50b, 50d oriented with the second side 82 of the pouch cell 50b, 50d facing the upper housing portion 14a, the negative cell tab 62 is positioned in the first column 82a and the positive cell tab 58 is positioned in the second column 82b. As such, the first column 82a includes three positive cell tabs 58 and two negative cell tabs 62, and the second column 82b includes three negative cell tabs 62 and two positive cell tabs 58. The first column 82a has a net positive charge, and the second column 82b has a net negative charge. As shown, the respective cell tabs 58, 62 are configured to be received through one of the plurality of slots in the fourth wall 28d.

In some embodiments, the cell pack assembly 26 may further include one or more intermediate layers 86 (FIG. 2) positioned between adjacent cells 50. The intermediate layers 86 may include, but are not limited to, an insulating layer, a cooling layer, an adhesive layer, a shielding layer, and the like. In still other embodiments, more than one intermediate layer 86 may be present between a pair of adjacent cells 50. In the intermediate layers 86 are configured to allow expansion of the body portion 54 of cells 50. That is, the intermediate layers 86 are deformable to allow expansion of the body portion 54 of cells 50. In some embodiments, the intermediate layers 86 may be formed all or in part from a foam material, an elastic material, or any suitable deformable material.

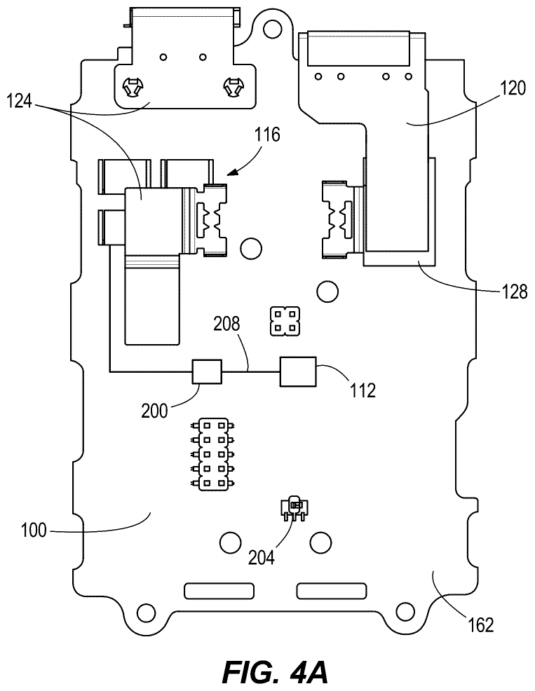

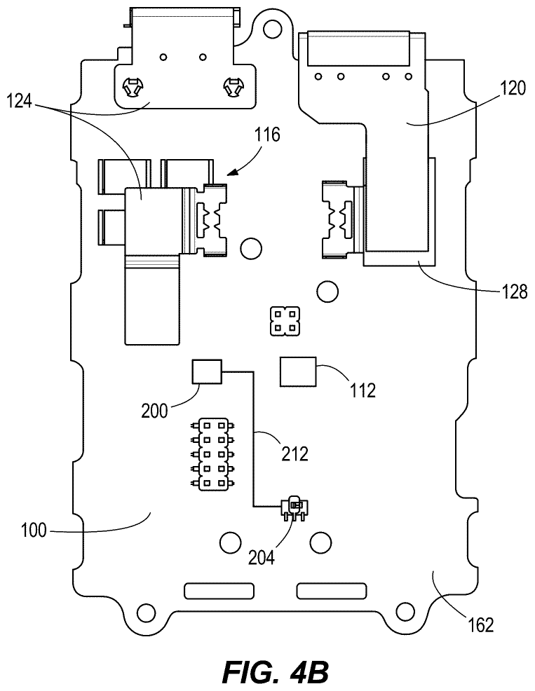

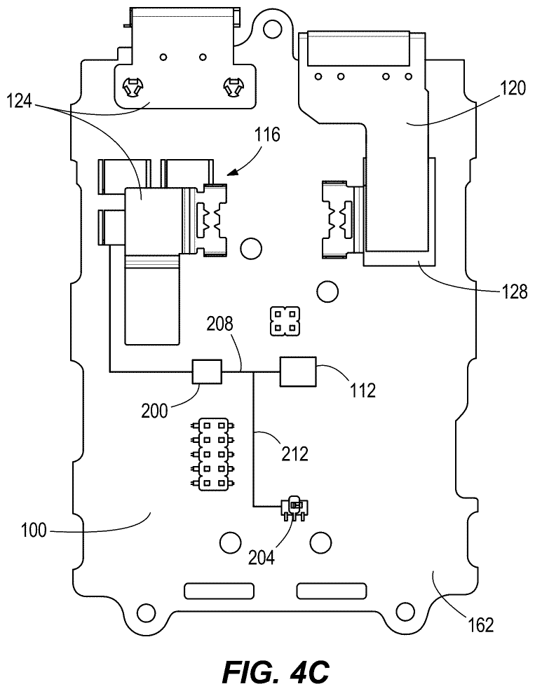

The resulting assembly of cells 50 and intermediate layers 86 also defines a stack axis B (FIG. 2) generally oriented normal to and passing through the geometric center of the top and bottom surfaces 78, 82 of each cell 50. The stack axis B is configured to be aligned with the direction in which the individual cells 50 are stacked. As shown in FIG. 4, the stack axis B is parallel to the height dimension 66 of each stacked cell 50. Further, the assembly of cells 50 and intermediate layers 86 collectively define a volume. Because the body portions of each of the battery cells 50 is able to expand and contract the volume of the assembly is able to fluctuate. In the illustrated embodiment, the body portions 54 may expand and contract in the thickness direction (e.g., 66) such that the volume of the assembly is able to fluctuate in a direction along the stack axis B. For example, prior to any of the cells 50 expanding (e.g., when the battery pack has not been used yet or for a period of time) the assembly of battery cells 50 (e.g., the stack) has a first height and a first volume and during use the height and the volume of the assembly may increase. If the battery cells 50, and therefore the assembly of battery cells 50, expand too much there is a risk that one or more of the battery cells 50 may explode and therefore cause a fire. Accordingly, it is desirable to monitor the volume of the battery cells 50 and/or the volume of the assembly of battery cells 50.

As illustrated in FIG. 3A, the battery management system 30 includes a first printed circuit board (PCB) 100 and a second PCB 104 are positioned within the interior volume and in communication with the battery cells 50. With additional reference to FIG. 2, the first PCB 100 contacts the three walls 28a, 28b, 28c of the interior housing 28. In other words, the first PCB 100 substantially covers the at least one opening 28e such that the first PCB 100 forms a surface of the interior housing 28. Returning reference to FIGS. 2 and 3, the second PCB 104 is disposed on a side of the first PCB 100 opposite that of the pouch cells 50. Stated another way, the first PCB 100 is positioned between the pouch cells 50 and the second PCB 104. A terminal block 108 is mounted to the second PCB 104 and is positioned to receive the electrical contacts 46 (FIG. 1) for outputting an electrical current to the device. The electrical contacts 46 are in electrical communication with both the first PCB 100 and the second PCB 104. The first PCB 100 may include a charge field-effect transistor 106 and a discharge field-effect transistor 107. The charge field-effect transistor 106 and the discharge field-effect transistor 107 are operable to control and direct a flow of current through the first PCB 100. Specifically, the charge field-effect transistor 106 controls current flow while the battery pack 10 is being charged (e.g., to the battery cells 50 via the electrical contacts 46). The first PCB 100 may include a plurality of charge field-effect transistors 106. The discharge field-effect transistor 107 controls current flow being discharged from the battery pack 10 (e.g., to a power tool via the electrical contacts 46).

With respect to FIG. 3A, the battery pack 10 further includes a positive cell strap 120, a negative cell strap 124, a plurality of connection pads 128, a plurality of voltage taps 132, and a flex circuit 136. The positive cell strap 120 is electrically connected to the first column of cell tabs 82a and thus has a net positive charge. The negative cell strap 124 is electrically connected to the second column of cell tabs 82b and thus has a net negative charge. The positive cell strap 120 is welded to a first connection pad 128 to provide an electrical and thermal connection between the positive cell strap 120 and the first PCB 100. The negative cell strap 124 is welded to a second connection pad to provide an electrical and thermal connection between the negative cell strap 124 and the first PCB 100. The plurality of voltage taps 132 between the cell tabs 58, 62 measure a voltage output of the pouch cells 50a-50c. The voltage taps 132 relay the voltage measurement to the flex circuit 136. The flex circuit 136 then directs the voltage measurement to the first PCB 100.

Turning reference to FIG. 2, the first PCB 100 further includes a first surface 162 and a second surface 166 opposite the first surface 162. The second surface 166 is closer to the pouch cells 50a-50e than the first surface 162. The first PCB 100 (FIG. 2) is a least partially formed of a metal having a thermal conductivity of at least 80 W/mK. In other embodiments, the metal may have a thermal conductivity of at most 260 W/mK. In further embodiments, the metal may have a thermal conductivity that is in a range of 80 W/mK to 260 W/mK. In the illustrated embodiment, the metal may be formed of up to 25% of aluminum. In other embodiments, the metal may be formed of up to 50% of aluminum. In further embodiments, the metal may be formed of up to 75% of aluminum. In even further embodiments, the metal may be formed entirely of aluminum. In the illustrated embodiment, the metal may be formed of an aluminum alloy such as aluminum alloy 6061, aluminum alloy 3003, aluminum alloy 1100, or another similar aluminum alloy.

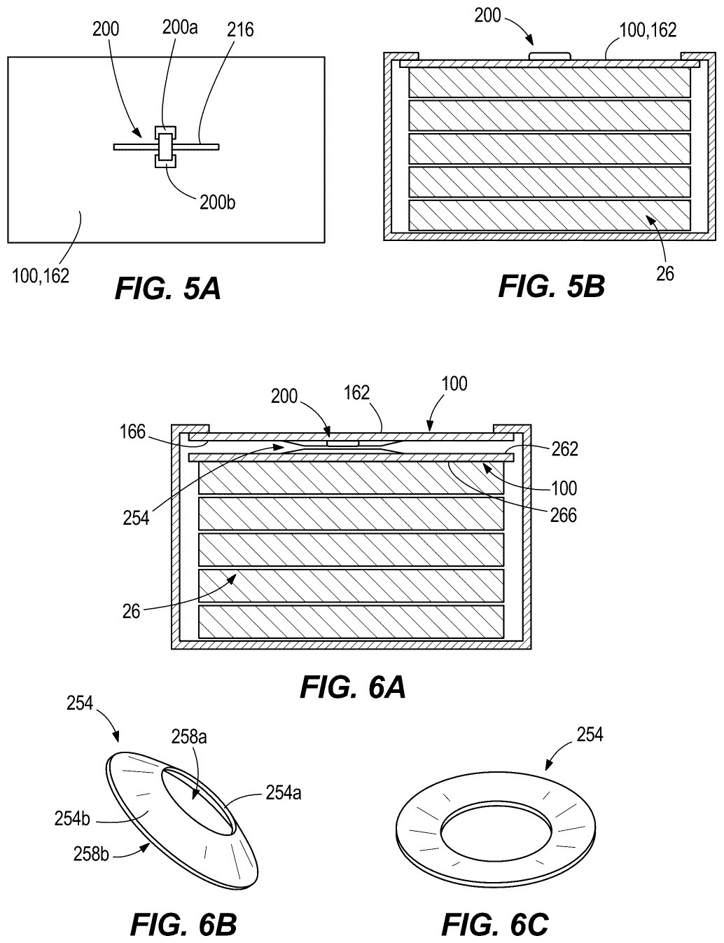

As shown, the first PCB 100 includes a plurality of electrical components mounted thereon on. In the embodiments of FIGS. 4A-5B, the plurality of electrical components includes, at least, a detector 200 and an indicator 204 that are coupled to the first surface 162. In some embodiments, the indicator 204 may be a visual indicator (e.g., an LED or the like) that generates a visual alert or an audio indicator an audible alert. The detector 200 is in electrical communication with the first PCB 100 and is configured to monitor the volume of the assembly of battery cells 50. When the detector 200 determines that the volume of the plurality of battery cells meets or exceeds a threshold volume, the detector 200 is configured to generate a signal configured to warn the operator of a status of the assembly of battery cells 50 or stop or otherwise interrupt current from flowing to and from the battery cells 50 (e.g., during charging via the charger and discharging to power a power tool). In one example, the detector 200 may be in electrical communication with a power line 208 of the first PCB 100 that is in electrical communication with the charge field-effect transistor 106 and the discharge field-effect transistor 107. Accordingly, when the detector 200 determines that the volume of the plurality of battery cells 50 meets or exceeds a threshold volume, the detector 200 is configured to generate a signal configured to stop or otherwise interrupt current from flowing to and from the battery cells 50 (e.g., during charging via the charger and discharging to power a power tool). In another example, the detector 200 may be in electrical communication with a dummy signal line 212 of the first PCB 100 such that when the detector 200 determines that the volume of the plurality of battery cells 50 meets or exceeds a threshold volume, the detector 200 is configured to generate a signal configured to warn the operator of a status of the assembly of battery cells 50 such that the operator can choose to stop or continue operation. The signal be sent to the indicator 204, which provides the alert (visually or auditorily) to the operator.

In the illustrated embodiments, the first PCB 100 is coupled to the walls 28a, 28b, 28c. Also, the first PCB 100 is a plate and therefore each of the first surface 162 and the second surface 166 are planar. When the volume of the assembly of battery cells 50 increases due to the expansion of one or more of the cells 50, a force (by the uppermost battery cell 50 and/or intermediate layer 86) is generated in the direction towards the first PCB 100, which causes the first PCB 100 to bow or otherwise deform (e.g., flex or bend). State another way, the contour of the first and second surfaces 162, 166 changes from flat or planar prior to an increase in volume of the assembly of battery cells 50 to curved as the volume of the assembly of battery cells 50 increases. The curvature of the surfaces 162, 166 may generally increase as the assembly of battery cells 50 continues to expand. Accordingly, a height of at least a portion of the first surface 162 relative to a bottom surface of the housing 14 increases as the volume of the assembly of battery cells 50 increases. For example, at least a portion of the first surface 162 may be at a first height relative to a bottom surface of the housing 14 prior to an expansion of the assembly of battery cells 14 and may be at a second, greater height relative to the housing 14 when the assembly of battery cells reaches the threshold volume.

In the embodiment of FIG. 4A-4C, the detector 200 is a strain gauge that is coupled to the first surface 162 of the first PCB 100. When the strain gauge 200 is positioned at the first height and when the first surface 162 is generally flat the strain gauge 200 has a first electrical resistance and when the strain gauge 200 is positioned at the second height and when the first surface 166 is curved, the strain gauge 200 has a second electrical resistance. When the volume of the assembly of battery cells 50 is less than a threshold volume, the strain gauge 200 has the first resistance such that the battery pack operates normally. When the volume of the assembly of battery cells 50 meets or exceeds the threshold volume, the strain gauge 200 generates the second resistance, which generates the signal configured to warn the operator of a status of the assembly of battery cells 50 via the dummy line (FIG. 4B) or stop current from flowing to and from the battery cells 50 via the power line (FIG. 4A), as discussed above. Therefore, the volume of the assembly of battery cells 50 correlates to an electrical parameter of a component of the first PCB 100, which in this case is electrical resistance of the strain gauge.

In another embodiment (FIG. 4C), the strain gauge 200 may be in electrical communication with both the power line 208 and the dummy signal line 212. As such, when the strain gauge 200 is positioned at the first height and when the first surface 162 is generally flat, the strain gauge 200 has the first electrical resistance. When the strain gauge 200 is positioned at the second height and when the first surface 166 has a first curvature, the strain gauge 200 has a second electrical resistance. When the strain gauge 200 is positioned at a third height relative to the bottom of the housing 14 (greater than the second height) and when the first surface 166 has a second curvature (greater than the first curvature), the strain gauge 200 has a third electrical resistance. When the volume of the assembly of battery cells 50 is less than a first threshold volume, the strain gauge 200 has the first resistance such that the battery pack 10 operates normally. When the volume of the assembly of battery cells 50 meets or exceeds the first threshold volume, the strain gauge 200 generates the second resistance, which generates a first signal configured to warn the operator of a status of the assembly of battery cells 50 via the dummy line 212. When the volume of the assembly of battery cells 50 meets or exceeds a second threshold volume, the strain gauge 200 generates the third resistance, which generates a second signal configured to stop current from flowing to and from the battery cells 50. In the embodiments of FIGS. 4A-4C, the strain gauge 200 is positioned on the first surface 162, but in other embodiments, the strain gauge 200 may be positioned on the second surface 166.

In the embodiments of FIG. 5A-5B, the first PCB 100 has a cutout 216. The detector 200 includes a first end 200a coupled to the first PCB 100 on a first side of the cutout 216 and a second end 200b coupled to the first PCB 100 on a second opposite side of the cutout 216. One of the first and second ends 200a, 200b of the detector 200 is in electrical communication with the power line 208 (not shown in FIGS. 5A-5B) or the dummy line 212 (not shown in FIGS. 5A-5B). In the embodiments, of FIG. 5A-5B, the detector 200 may be a resistor or a capacitor. In either case, as the first PCB 100 bows or otherwise deforms and the height of the cutout 216 increases, the detector 200 will crack or break thereby disrupting or otherwise changing electrical properties thereof. That is, when the detector 200 is a resistor and the resistor cracks, the resulting change in resistance generates the signal configured to warn the operator of a status of the assembly of battery cells 50 via the dummy line 212 or to stop current from flowing to and from the battery cells 50 via the power line 208, as discussed above. Similarly, when the detector 200 is a capacitor and the capacitor cracks, the resulting change in capacitance generates the signal configured to warn the operator of a status of the assembly of battery cells 50 via the dummy line 212 or to stop current from flowing to and from the battery cells 50 via the power line 208, as discussed above. Again, therefore, the volume of the assembly of battery cells 50 correlates to an electrical parameter of a component of the first PCB 100, which in this case is electrical resistance or capacitance of the respective resistor or capacitor.

In another embodiment, a support 250, rather than the first PCB 100, may move relative to the housing 14 (and relative to the core box 28) to monitor the volume expansion of the assembly of battery cells 50. As shown in FIG. 6A, a support 250 is positioned between the battery cells 50 and the first PCB 100. The support 250 is configured to be movable with the assembly of battery cells 50 as the volume thereof fluctuates and is also configured to exert compression onto the assembly of battery cells 50. A biasing mechanism 254 is positioned between the support 250 and the first PCB 100. The biasing mechanism 254 is configured to bias the support 250 away from the first PCB 100. A detector or switch 200 is positioned between the first PCB 100 and the support 250 and is in selective communication with the first PCB 100. As the volume of the assembly of battery cells 50 expands, the support 250 moves towards the first PCB 100 against the bias of the biasing mechanism 254. When the volume of the assembly of battery cells 50 expands to a threshold volume, the switch 200 is configured to be actuated to generate a signal configured to warn the operator of a status of the assembly of battery cells 50 or to stop current from flowing to and from the battery cells 50. Moreover, prior to the volume of the assembly of battery cells 50 expanding the support 250 is spaced apart from the first PCB 100 by a first distance and when the volume of the assembly of battery cells 50 reaches the threshold volume the support 250 is spaced apart from the first PCB 100 by a second distance that is smaller than the first distance thereby causing actuation of the switch 200.

In the illustrated embodiment, the biasing mechanism 254 is configured as one or more Belleville washers, each of which has a first end 254a that engages the first PCB 100 or the support 250 and a second opposite end 254b that engages the first PCB 100 or the support 250. The first end 254a includes an opening 258a having a first dimension (e.g., diameter) and the second end 254b includes an opening 258b having a second dimension (e.g., diameter) that is greater than the first dimension. The washers 254 may be positioned relative to one another and to the first PCB 100 and support 250 in any suitable manner. In the illustrated embodiment the switch 200 is generally positioned to be at a center point of each of the openings 258a, 258b. In the illustrated embodiment, there are two Belleville washers 254. In other embodiments, there may be more of fewer Belleville washers 254. In other embodiments, the biasing mechanism may include one or more compression springs or one or more elastic members formed from a generally elastic material (such as foam).

The support 250 has a first surface 262 that is positioned adjacent to the first PCB 100 and a second surface 266 that is positioned adjacent to assembly of battery cells 50. In the illustrated embodiment, the switch 200 is coupled to the first surface 262 of the support 250 such that when the support 250 is positioned at the second distance the switch 200 depresses thereby generating the signal. That is, when the support 250 is positioned at the second distance the support 250 is close enough to the second surface 166 of the first PCB that a force on the support 250 in the direction of the first PCB causes the switch 200 to depress. In another embodiment, not shown, a projection may extend from the second surface 166 of the first PCB 100 such that when the support 250 is positioned at the second distance the support 250 is close enough to the second surface 166 of the first PCB that the force on the support 250 in the direction of the first PCB 100 causes the projection to contact and depress the switch 200. In another embodiment, not shown, the switch 200 is coupled to the second surface 266 such that when the support 250 is positioned at the second distance the switch 200 contacts a line on the second surface 166, which is in communication with power line 208 or the dummy line 212, of the first PCB 100 thereby generating the signal. In another embodiment, not shown, a projection may extend from the second surface 166 of the first PCB 100 and the projection may be in electrical communication with a line of the first PCB 100, which is in communication with the dummy line 212 or the power line 208, such that when the support 250 is positioned at the second distance the switch 200 contacts the projection on the second surface 166, thereby generating the signal. Moreover, in still other embodiments, not shown, the switch 200 may be coupled to the second surface 166 of the first PCB 100 and a projection is coupled to the first surface 262 of the support 250 such that when the support 250 is positioned at the second distance the projection engages the switch 200 thereby generating the signal.

Although the disclosure has been described in detail with reference to certain preferred embodiments, variations and modifications exist within the scope and spirit of one or more independent aspects of the disclosure as described.

1. A battery pack comprising:
a housing at least partially defining an interior volume therein;
a cell pack assembly at least partially positioned within the interior, the cell pack assembly including a plurality of battery cells that collectively define a volume, wherein each battery cell includes a body, an anode extending from the body, and a cathode extending from the body, the body of each of the cells configured to expand and contract;
a printed circuit board electrically connected to the plurality of battery cells;
electrical contacts in communication with the plurality of battery cells via the printed circuit board and configured to provide electrical power to an external device; and
a detector in electrical communication with the printed circuit board,
wherein when the detector determines that the volume of the plurality of battery cells meets or exceeds a threshold volume, the detector is configured to generate a signal configured to warn the operator of a status of the stack or stop current from flowing to and from the plurality of battery cells.

2. The battery pack of claim 1, wherein the threshold volume is a first threshold volume, and wherein when the detector determines that the volume of the plurality of battery cells meets or exceeds the first threshold volume, the signal is a first signal that is generated by the detector and configured to warn the operator of the status of the stack, and when the detector determines that the volume of the plurality of battery cells meets or exceeds a second threshold volume, the detector is configured to generate a second signal configured stop current from flowing to and from the plurality of battery cells, the second threshold volume being greater than the first threshold volume.

3. The battery pack of claim 1, wherein the plurality of battery cells and the printed circuit board are stacked along a stack axis, the detector being positioned at a first height relative to a bottom surface of the housing prior to the expansion of the cells, and wherein the expansion of the plurality of battery cells to the threshold volume moves the detector to a second height relative to the bottom surface, the second height being greater than the first height.

4. The battery pack of claim 3, wherein the detector is a strain gauge, and wherein when the strain gauge is positioned at the first height the strain gauge has a first electrical resistance and when the strain gauge is positioned at the second height the strain gauge has a second electrical resistance.

5. The battery pack of claim 3, wherein the detector is a resistor, and wherein moving the resistor from the first height to the second height causes the resistor to crack thereby changing the resistance of the resistor.

6. The battery pack of claim 3, wherein the detector is a capacitor, and wherein moving the capacitor from the first height to the second height causes the capacitor to crack thereby changing the capacitance of the capacitor.

7. The battery pack of claim 1, wherein the plurality of battery cells and the printed circuit board are stacked along a stack axis, and wherein a surface of the printed circuit board on which the detector is positioned is planar prior to the expansion of the plurality of battery cells, and wherein the expansion of the plurality of battery cells to the threshold volume causes the surface of the printed circuit board to become curved.

8. The battery pack of claim 7, wherein the detector is a strain gauge, and wherein when the strain gauge is planar the strain gauge has a first electrical resistance and when the strain gauge is curved the strain gauge has a second electrical resistance.

9. The battery pack of claim 7, wherein the detector is a resistor, and wherein moving the surface from being flat to being curved causes the resistor to crack thereby changing the resistance of the resistor.

10. The battery pack of claim 7, wherein the detector is a capacitor, and wherein moving the surface from being flat to being curved causes the capacitor to crack thereby changing the capacitance of the capacitor.

11. The battery pack of claim 1, wherein the detector is one of a strain gauge, a resistor, and a capacitor.

12. A battery pack comprising:
a housing at least partially defining an interior volume therein;
a cell pack assembly at least partially positioned within the interior volume, the cell pack assembly including a plurality of battery cells configured in a stack having a stack axis, wherein each battery cell includes a body, an anode extending from the body, and a cathode extending from the body, the body of each of the cells configured to expand and contract;
a printed circuit board electrically connected to the plurality of battery cells;
electrical contacts in communication with the plurality of battery cells via the printed circuit board and configured to provide electrical power to an external device;
a support positioned between the stack and the printed circuit board, the support being movable with the stack as the volume of the stack changes;
a biasing mechanism positioned between the support and the printed circuit board, the biasing mechanism configured to bias the support away from the printed circuit board;
a switch positioned between the printed circuit board and the support and in selective communication with the printed circuit board;
wherein when as the volume of the stack expands, the support moves towards the printed circuit board against the bias of the biasing mechanism, and
wherein when the volume of the stack expands to a threshold volume, the switch is configured to be actuated to generate a signal configured to warn the operator of a status of the stack or to stop current from flowing to and from the plurality of battery cells.

13. The battery pack of claim 12, wherein prior to the volume of the stack expanding the support is spaced apart from the printed circuit board by a first distance and when the volume of the stack reaches the threshold volume the support is spaced apart from the printed circuit board by a second distance that is smaller than the first distance thereby causing actuation of the switch.

14. The battery pack of claim 13, wherein the printed circuit board has a first surface and the support has a second surface that is positioned adjacent to the first surface, the switch being coupled to the second surface such that when the support is positioned at the second distance the switch depresses thereby generating the signal.

15. The battery pack of claim 13, wherein the printed circuit board has a first surface and the support has a second surface that is positioned adjacent to the first surface, the switch being coupled to the second surface such that when the support is positioned at the second distance the switch contacts the printed circuit board thereby generating the signal.

16. The battery pack of claim 13, wherein the printed circuit board has a first surface and the support has a second surface that is positioned adjacent to the first surface, the switch being coupled to the first surface and the second surface including a projection such that when the support is positioned at the second distance the projection engages the switch thereby generating the signal.

17. The battery pack of claim 12, wherein the biasing mechanism includes one or more Belleville washers with an opening.

18. The battery pack of claim 17, wherein the switch is positioned to be concentric within the opening of the Belleville washer and is oriented along the stack axis.

19. A method of measuring expansion a plurality of battery cells in a battery pack, the plurality of battery cells collectively defining a volume, wherein each battery cell includes a body, an anode extending from the body, and a cathode extending from the body, the body of each of the cells configured to expand and contract, the battery pack including electrical contacts in communication with the plurality of battery cells, the method comprising:
providing a printed circuit board in electrical communication with the plurality of battery cells;
providing a detector in electrical communication with the printed circuit board;
when expansion of the plurality of battery cells exceeds a threshold volume, the detector is configured to generate a signal that is configured to warn the operator of a status of the stack or to stop current from flowing to and from the plurality of battery cells.

20. The method of claim 19, wherein providing a detector includes providing the detector on a surface of the printed circuit board, and wherein when expansion of the plurality of battery cells exceeds the threshold volume, a contour of the surface of the printed circuit board changes thereby causing the detector to generate the signal.

21. The method of claim 20, wherein the detector is a strain gauge, a resistor, or a capacitor.

22. The method of claim 19, further comprising
providing a support that is movable with the plurality of battery cells as the plurality of battery cells expands, the detector coupled to the support, and
providing a biasing mechanism between the printed circuit board and the support,
wherein when expansion of the plurality of battery cells exceeds the threshold volume, the support moves towards the printed circuit board against the bias of the biasing mechanism to actuate the detector thereby causing the detector to generate the signal.
